(19) United States
(12) Patent Application Publication
(10) Pub. No.: US 2008/0166606 A1
(43) Pub. Date: Jul. 10, 2008

(54) Hydrogen generator and fuel cell using the same

(76) Inventors: Do-young Kim, Suwon-si (KR); Ho-jin Kweon, Suwon-si (KR); Won-hyouk Jang, Suwon-si (KR); Sung-jin Kim, Suwon-si (KR)

Correspondence Address: ROBERT E. BUSHNELL, 1522 K STREET NW, SUITE 300, WASHINGTON, DC, 20005-1202, US

(21) Appl. No.: 12/007,364

(22) Filed: Jan. 9, 2008

(30) Foreign Application Priority Data
Jan. 9, 2007 (KR) 10-2007-0002534

(51) Int. Cl. H01M 8/18

(52) U.S. Cl. 429/19

(57) ABSTRACT

A hydrogen generator using a chemical hydride includes a reactor which stores an aqueous solution of chemical hydride, a catalyst which catalyzes the reaction of the aqueous solution of chemical hydride and water to generate hydrogen, a transferring device for transferring the catalyst into the aqueous solution of chemical hydride and after bring the catalyst into contact with the aqueous solution of chemical hydride within a predetermined time, separating them, and a temperature controller to maintain temperature of the aqueous solution of chemical hydride at a predetermined temperature.

### CROSS-REFERENCE TO RELATED APPLICATION AND CLAIM OF PRIORITY

This application claims priority to and the benefit of Korean Patent Application No. 10-2007-0002534, filed on Jan. 9, 2007, in the Korean Intellectual Property Office, the entire content of which is incorporated herein by reference.

### BACKGROUND

1. Field of the Invention

The present invention relates to a hydrogen generator a fuel cell using the same.

2. Description of the Relates Art

The fuel cell which is a nonpolluting power supplying device has been spotlighted as one of the clean energy power generation systems for the next generation. The power generation system using the fuel cell is used for an independent power generator of large sized buildings, power supply of electric cars, portable power supply and etc. and it has the advantage of being capable of using various fuel such as natural gas, methanol, petroleum, liquefied petroleum gas (LPG), dimethyl ether (DME), coal, waste gas and etc. The fuel cells are basically operated based on the same principle and according to various sorts of internal electrolyte used, fuel cells can be categorized as phosphoric acid, alkaline, polymer electrolyte, direct methanol and solid oxide fuel cells.

Among the above mentioned fuel cells, a polymer electrolyte membrane fuel cell (PEMFC) using polymer as electrolyte has no risk of the corrosion or evaporation of the electrolyte and obtains high current density per unit area. Further, since the polymer electrolyte membrane fuel cell (PEMFC) has the advantage of a remarkably high output feature and a low operating temperature feature over other fuel cells, it has actively been developed for being applicable to a mobile power source, such as a portable electronic equipment or a transportable power source, such as a power source for automobile as well as a distributed power source, such as a stationary power plant used in a house and a public building, etc.

A direct methanol fuel cell (DMFC) which is another type of fuel cells using polymer membrane as electrolyte uses directly liquefied fuel such as methanol or etc. without using a fuel reformer, and is operated at temperature less than 100° C. so that it is suitable for portable or small-sized power supply.

A high over-voltage is generated by crossover in a cathode of the DMFC, thereby reducing output density and energy density. Meanwhile, in the case of PEMFC using directly hydrogen gas without a fuel reformer, the PEMFC may obtain a small-sized fuel cell for high output that complements disadvantage of the DMFC. Accordingly, in order to implement the small-sized fuel cell for high output, ways to generate hydrogen without using the fuel reformer have been required.

It has recently been researched that fuel cells using a chemical hydride such as a sodium borohydride. As a example, a hydrogen generator disclosed in US 20030014917 A1 (Jan. 23, 2003) is configured to control the amount of generated hydrogen by controlling the amount of a chemical hydride supplied to a reactor according to the hydrogen pressure in the reactor. In this method, however, after the reactor receives the information of the hydrogen pressure, compares it with a predetermined reference, then the reactor controls the amount of the chemical hydride supplied to the reactor according to the comparison. Accordingly, there is time-lag between the time point of controlling the hydrogen generator and the time point of the generation of hydrogen in the reactor. The prior method, therefore, has problems that it is difficult to operate safely and continuously due to the amount of hydrogen supplied to an anode of a fuel cell stack with high fluctuation.

### SUMMARY OF THE INVENTION

The present invention is to provide an improved hydrogen generator and an improved fuel cell.

According to an embodiment of the present invention, a new hydrogen generator using a chemical hydride is provided.

According to an embodiment of the present invention, a hydrogen generator capable of controlling constantly and easily the amount of generated hydrogen regardless of the temperature effect of the surrounding environment is provided

According to an embodiment of the present invention, an improved fuel cell is provided.

According to an embodiment of the present invention, a fuel cell employing the hydrogen generator which is small-sized and has high output is provided.

According to a first aspect of the present invention to achieve at least one of the above technical subject, there is provided a hydrogen generator including a reactor for containing an aqueous solution of chemical hydride therein; a catalyst for generating hydrogen by a chemical reaction between the aqueous solution of chemical hydride and water; a transferring device capable of transferring the catalyst into the aqueous solution of chemical hydride and transferring the catalyst out of the aqueous solution of chemical hydride; and a temperature controller maintaining temperature of the aqueous solution of chemical hydride at a predetermined temperature.

According to a second aspect of the present invention to achieve the above technical subject, there is provided a hydrogen generator including a fuel tank for storing an aqueous solution of chemical hydride; a reactor connected to the fuel tank to receive the aqueous solution of chemical hydride from the fuel tank; a catalyst packed in the reactor for generating hydrogen by a reaction between the aqueous solution of chemical hydride supplied from the fuel tank and water; and a temperature controller maintaining temperature of the reactor within a predetermined narrow temperature range.

According to a third aspect of the present invention, there is provided a fuel cell including a hydrogen generator comprising a reactor containing an aqueous solution of chemical hydride, a catalyst catalyzing the reaction of the chemical hydride and water to generate hydrogen, a temperature sensor detecting temperature of the aqueous solution of chemical hydride in the reactor, and a temperature controller maintaining the temperature of the aqueous solution of chemical hydride in the reactor at a predetermined temperature; an electricity generator generating electric energy by an electrochemical reaction between the hydrogen supplied from the hydrogen generator and oxidizer; a detector detecting an output current and an output voltage of the electricity generator and outputting a signal of the detected output current and the output voltage; and a controller controlling the amount of hydrogen generated from the hydrogen generator based on the signal transferred from the detector and controlling the temperature controller based on the temperature detected by the temperature sensor.

According to a fourth aspect of the present invention, there is provided a method of regulating an amount of a chemical reaction in a hydrogen generator comprising: Measuring a temperature of the hydrogen generator; Communicating the temperature signal to control circuit; Determining whether the temperature is at a predetermined temperature range; Decreasing an amount of the chemical reaction between a catalyst and an aqueous solution of chemical hydride when the temperature of the hydrogen generator is higher than the predetermined temperature range.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components.

FIG. 1 is a schematic view of a fuel cell employing a hydrogen generator according to an embodiment of the present invention.

FIG. 2 is a schematic view of the hydrogen generator according to a first embodiment of the present invention.

FIG. 3 is a schematic view of the hydrogen generator according to a second embodiment of the present invention.

### DETAILED DESCRIPTION OF THE EXEMPLARY EMBODIMENTS

Hereinafter, certain exemplary embodiments according to the present invention will be described with reference to the accompanying drawings. Here, when a first element is described as being coupled to a second element, the first element may be not only directly coupled to the second element but may also be indirectly coupled to the second element via a third element. Further, elements that are not essential to the complete understanding of the invention are omitted for clarity. Also, like reference numerals refer to like elements throughout.

In the following detailed description the present invention will be concretized and described as a fuel cell system using sodium borohydride (NaBH₄) or sodium borohydride aqueous solution. However, it is natural that the idea of the present invention can be also applied to a fuel cell system using lithium borohydride (LiBH₄), lithium hydride (LiH), sodium hydride (NaH) as fuel. This, of course, is within the scope of the present invention.

Also, in the following detailed description, a term “fuel cell stack” is used. However, this is for convenience in using terms. The term “fuel cell stack” used in the description of the present invention is a term of concept including all of a stack constituted by stack type unit cells, a stack constituted by flat panel type unit cells, a unit stack comprising a single unit cell.

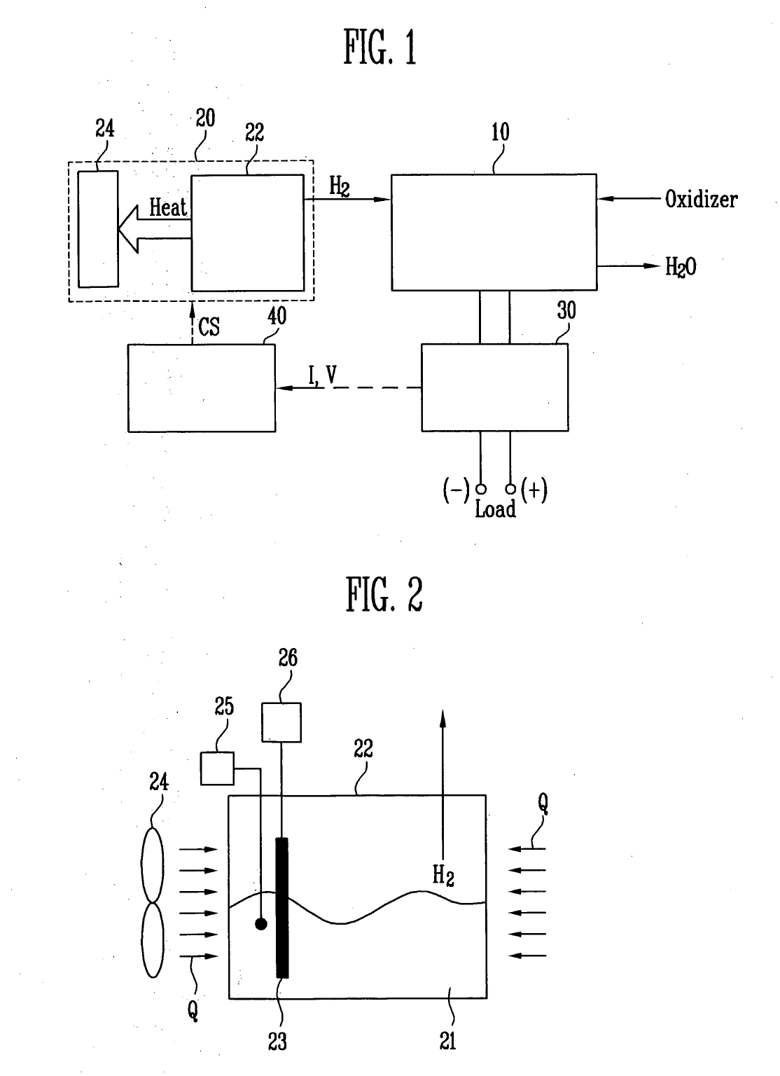

FIG. 1 is a schematic view of an embodiment of a fuel cell employing a hydrogen generator according to an embodiment of the present invention.

Referring to FIG. 1, a fuel cell of the embodiment of the present invention includes an electricity generator 10 and a hydrogen generator 20 using sodium borohydride (NaBH₄). Also, it may further include a detector 30 and a controller 40.

The fuel cell according to an embodiment maintains desired temperature of a reactor 22 or sodium borohydride aqueous solution contained in the reactor 22 by using a temperature controller 24 when temperature of the reactor 22 of the hydrogen generator 20 increases by an exothermic reaction between sodium borohydride and water or a temperature effect of the surrounding environment.

A reaction formula between sodium borohydride and water is as follows.

NaBH₄+2H₂O→NaBO₂+4H₂ [reaction formula 1]

As describing in more detail, it is necessary to control flux of generated hydrogen in the hydrogen generator. The reaction of sodium borohydride, water and catalyst to generate hydrogen is an zero order reaction. A reaction is zero order if concentration data are plotted versus time and the result is a straight line. In other words, the hydrogen generator using sodium borohydride generates a constant amount of hydrogen with a predetermined catalyst, amount of the catalyst, temperature, and concentration of sodium borohydride as time passes, if the reaction temperature is constant. But, when the hydrogen generator using sodium borohydride generally generates hydrogen at room temperature, temperature rises by an exothermic reaction as time passes. When the temperature is increased, the flux of hydrogen generated from the hydrogen generator 20 increases as time passes. Due to the change of the temperature, the fuel cell cannot be stably operated for a long time. Accordingly, temperature of the reactor 22 or the sodium borohydride aqueous solution in the reactor is maintained at a predetermined temperature and flux of hydrogen generated from the hydrogen generator is almost uniformly controlled so that a stable operation environment of the fuel cell is provided in the hydrogen generator of the embodiment of the present invention.

In the embodiment, when flux of hydrogen to be supplied to the electricity generator 10 is 100 to 110 ccpm (cubic centimeters per minute), temperature of the reactor 22 or the sodium borohydride aqueous solution in the reactor may be controlled by 35° C. to 38° C. Further, when the electricity generator 10 is used for power supply of cars, temperature of the reactor 22 or the sodium borohydride aqueous solution in the reactor may be controlled by about 100° C. or so in order to generate flux of hydrogen corresponding to a high output. Also, when the electricity generator 10 is used for electric devices such a notebook computer or etc. requiring power of more than 5 W and less than 20 W, temperature of the reactor 22 or sodium borohydride aqueous solution in the reactor may be controlled by about 60° C. or so. When the hydrogen generator is used for electric devices requiring power of less than 5 W, temperature of the reactor 22 or sodium borohydride aqueous solution in the reactor may be controlled by about 40° C. or so.

The electricity generator may be a polymer electrolyte membrane fuel cell which is suitable for a small size and high output. The polymer electrolyte membrane fuel cell includes an anode and cathode which are positioned to be opposite to each other and a polymer electrolyte membrane interposed between the anode and the cathode. The polymer electrolyte membrane may be formed of fluorine polymer such as Nafions, polybenzimidazole (PBI) or nonfluoride polymer such as polymer compound membrane consisting of ion conductible material and ion exchange resin. The hydrogen generator 10 may have a stack structure in which a plurality of unit cells are stacked including a bipolar plate, or a plate type structure in which a plurality of unit cells are disposed on a more than one stored plane.

Further, the electricity generator 10 may be a dead end type having a closed end of the channel of the anode side through which hydrogen is supplied from the hydrogen generator 20 or an open end type having an open end of the channel of the anode. When the electricity generator is the dead end type, hydrogen supplied to the electricity generator 10 from the hydrogen generator 20 is controlled corresponding to the available amount of hydrogen. Here, the pressure of hydrogen supplied from the hydrogen generator 10 is controlled to be close to standard pressure determined according to a form of the electricity generator 10. On the other hands, when the electricity generator is the open end type, non-reacted hydrogen discharged from the anode side of the electricity generator 10 can be recycled. The fuel cell of the embodiment of the present invention may further include a pressure regulator which can be disposed in a front part of the electricity generator 10 to constantly maintain pressure of the electricity generator 10.

A detector 30 measures output current I and output voltage V of the electricity generator 10 and transfers the measured values to a controller 40. The detector 30 may be a current sensor and a voltage sensor or a functioning unit of a power converter which has a current sensor and a voltage sensor and which is connected to the electricity generator 10 and an external load.

The controller 40 supplies a control signal CS for controlling the hydrogen generator 20 in order to make the sodium borohydride aqueous solution and a catalyst be in contact. The controller 40 may include a logic circuit using flip-flop or a microprocessor. Also, in the fuel cell, output density of the electricity generator 10 is increased as much as flux of hydrogen supplied to the anode of the electricity generator 10 is increased, and output density of the electricity generator 10 decreased as much as flux of hydrogen supplied to the anode of the electricity generator 10 is decreased. Accordingly, the controller 40 of an embodiment of the present invention may control flux of hydrogen generated from the hydrogen generator 20 based on output information of the electricity generator 10 sensed by the detector 30.

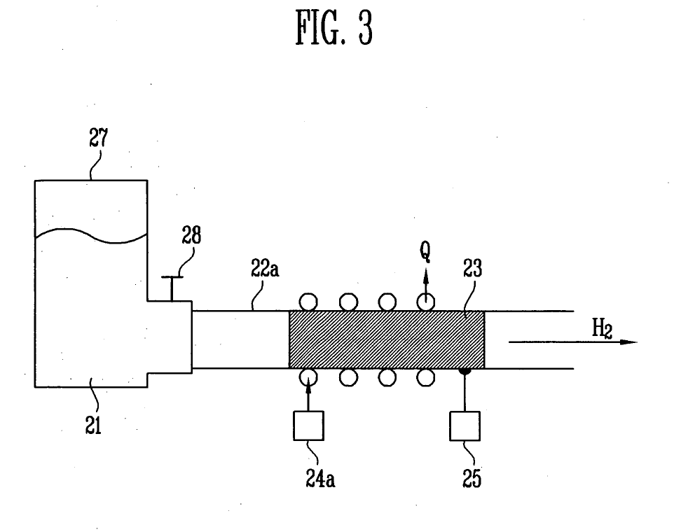

FIG. 2 is a schematic view of the hydrogen generator according to a first embodiment of the present invention.

Referring to FIG. 2, a hydrogen generator of the embodiment of the present invention includes a reactor 22 for storing a sodium borohydride aqueous solution 21, a catalyst 23 to catalyze a reaction of sodium borohydride in the sodium borohydride aqueous solution 21 and water in order to generate hydrogen, a temperature controller 24 to maintain the temperature of the sodium borohydride aqueous solution 21 contained in the reactor 22 at a predetermined temperature, a temperature sensor 25 to measure the temperature of the sodium borohydride aqueous solution 21 positioned near the catalyst 23 when the catalyst 23 is contacted with the sodium borohydride aqueous solution 21, and a transferring device 26 to soak the catalyst 23 in the sodium borohydride aqueous solution 23 and then taking it out of the sodium borohydride aqueous solution.

The temperature controller 24 of the embodiment may include a fan. The controller 24 may include a temperature controlling apparatus such as an air cooling system, etc. for decreasing temperature of the reactor 22 and the sodium borohydride aqueous solution 21 contained in the reactor 22 by compulsory air flow.

The bar shaped platinum or a platiniferous catalyst can be used for the catalyst 23. A form of the catalyst 23 is not limited specifically. For example, when the catalyst 23 has a bead shape, the catalyst can be placed in the reticular formation having holes smaller than the size of the catalyst and can be submerged in the sodium borohydride aqueous solution 23.

The reactor 22 has chemical resistance for a chemical reaction between sodium borohydride and water. It may be formed of material and may have a form which can be easily cooled by the flow of the coolant Q. For example, the reactor 22 is preferably formed of metal material such as stainless steel.

The temperature sensor 25 produces a signal corresponding to a detected temperature and transfers the produced signal to the controller. The controller receives a signal transferred from the temperature sensor 25 and controls the operation of the temperature controller 24 corresponding to the signal. Temperature of the reactor 22 is usually increased as time passes since a reaction producing hydrogen by using sodium borohydride is an exothermic reaction. Accordingly, the controller 24 cools the reactor 22 by operating the fan for a time corresponding to difference between the transferred signal and a standard level if the signal transferred from the temperature sensor 25 is above a standard level.

The transferring device 26 is connected to the catalyst 23 and soaks the catalyst 23 in the sodium borohydride aqueous solution and takes it out of the sodium borohydride aqueous solution according to a control signal of the controller. For example, the transferring device 26 includes an apparatus using a pressure difference to make the catalyst 23 contact the sodium borohydride aqueous solution 21 or not contact the sodium borohydride aqueous solution 21. Also, if the transferring device 26 is a device which can move the catalyst 23 upwardly and downwardly as shown in FIG. 2, the form or shape of the transferring device 26 is not limited.

Operation principle of the hydrogen generator according to the embodiment is as follows.

First, if the catalyst 23 is soaked in the sodium borohydride aqueous solution 21 by the transferring device 26, a certain amount of hydrogen corresponding to a type of a catalyst, an amount of the catalyst and a concentration of sodium borohydride is generated in the reactor 22. Next, as time passes, the temperature of the sodium borohydride aqueous solution 21 and the temperature of the reactor 22 containing the sodium borohydride aqueous solution 21 are increased by an exothermic reaction in the reactor 22. Therefore, a catalyst reaction is more activated and the flux of generated hydrogen in the reactor 22 is increased.

If the temperature detected by the temperature sensor 25 is above the established standard temperature, the controller operates the temperature controller 24 to cool the reactor 22 and the sodium borohydride aqueous solution of the reactor.

If temperature detected by the temperature sensor 25 returns to the predetermined standard temperature, the controller stops operation of the temperature controller 24. According to a structure described above, the flux of hydrogen generated from the reactor 22 of the hydrogen generator using sodium borohydride is easily controlled in the established flux.

FIG. 3 is a schematic view of the hydrogen generator according to a second embodiment of the present invention.

Referring to FIG. 3, the hydrogen generator of an embodiment of the present invention includes a reactor 22a, a catalyst 23, a temperature controller 24a, a temperature sensor 25, a fuel tank 27 and a valve 28.

The hydrogen generator generates hydrogen by making sodium borohydride 21 flow in the reactor 22a containing the catalyst 23. Here, temperature of the reactor 22a is maintained near the desired temperature by the temperature controller 24a.

The fuel tank 27 stores the sodium borohydride aqueous solution 21 and has an outlet for discharging the sodium borohydride aqueous solution 21. The valve 28 to control discharge of the sodium borohydride aqueous solution 21 is installed at the outlet of the fuel tank 27. If a degree of opening of the valve 28 is controlled in the desired temperature, basic flux of hydrogen generated from the hydrogen generator 22a can be controlled. The valve 28 may be automatically controlled by the controller.

The reactor 22a is connected to the outlet of the fuel tank 27 and has the catalyst 23 packed therein. The sodium borohydride aqueous solution 21 flowed in to the reactor 22a is converted into hydrogen while passing through the catalyst 23.

The temperature controller 24a is mounted on an outside surface of the reactor 22a and cools the reactor 22a by heat exchange. The temperature controller 24a of the embodiment may be a water-cooling system having a spiral pipe surrounding the reactor 22a. The water-cooling system reduces the temperature of the reactor 22a by depriving thermal energy of the reactor 22a by flow of the liquefied coolant Q such as water and etc.

In the present invention, a constant amount of hydrogen is generated from the hydrogen generator using sodium borohydride so that the fuel cell can be stably operated for a long time.

As described above, a constant flux of hydrogen can be generated regardless of a temperature effect of the surrounding environment according to the present invention. And, stable operating environment of the fuel cell can be provide for a long time since the constant flux of hydrogen is supplied to the electricity generator of the fuel cell system.

Although exemplary embodiments of the present invention have been shown and described, those skilled in the art would appreciate that changes may be made to the embodiments without departing from the principles and spirit of the invention, the scope of which is defined in the claims and their equivalents.

What is claimed is:

1. A hydrogen generator, comprising:
a reactor containing an aqueous solution of chemical hydride;
a catalyst to generate hydrogen by a chemical reaction between the chemical hydride and water;
a transferring device capable of transferring the catalyst into the aqueous solution of chemical hydride and transferring the catalyst out of the aqueous solution of chemical hydride; and
a temperature controller maintaining temperature of the aqueous solution of chemical hydride at a predetermined temperature.

2. The hydrogen generator according to claim 1, wherein the temperature controller includes one of an air-cooling system, a water-cooling system and a combination of them.

3. The hydrogen generator according to claim 1, further comprising a temperature sensor to measure temperature of the aqueous solution of chemical hydride near the catalyst.

4. A hydrogen generator, comprising:
a fuel tank storing an aqueous solution of chemical hydride;
a reactor connected to the fuel tank to receive the aqueous solution of chemical hydride from the fuel tank;
a catalyst packed in the reactor to generate hydrogen by a reaction between the chemical hydride supplied from the fuel tank and water; and
a temperature controller maintaining temperature of the reactor at a predetermined temperature.

5. The hydrogen generator according to claim 4, wherein the temperature controller includes one of an air-cooling system, a water-cooling system and a combination of them.

6. The hydrogen generator according to claim 4, further comprising a temperature sensor to measure temperature of the reactor.

7. A fuel cell comprising:
a hydrogen generator comprising a reactor containing an aqueous solution of chemical hydride, a catalyst catalyzing the reaction of the chemical hydride and water to generate hydrogen, a temperature sensor detecting temperature of the aqueous solution of chemical hydride in the reactor, and a temperature controller maintaining the temperature of the aqueous solution of chemical hydride in the reactor at a predetermined temperature;
an electricity generator generating electric energy by an electrochemical reaction between the hydrogen supplied from the hydrogen generator and oxidizer;
a detector detecting an output current and an output voltage of the electricity generator and outputting a signal of the detected output current and the output voltage; and
a controller controlling the amount of hydrogen generated from the hydrogen generator based on the signal transferred from the detector and controlling the temperature controller based on the temperature detected by the temperature sensor.

8. The fuel cell according to claim 7, wherein the hydrogen generator further comprises:
a transferring device capable of transferring the catalyst into the aqueous solution of chemical hydride and transferring the catalyst out of the aqueous solution of chemical hydride to control the reaction of the aqueous solution of chemical hydride and the water.

9. The fuel cell according to claim 8, wherein the temperature controller comprises a cooling system operating to cool the aqueous solution of chemical hydride, and the cooling system is controlled by the controller according to the temperature sensed by the temperature sensor.

10. The fuel cell according to claim 8, wherein the controller controls operation of the transferring device based on the signal transferred from the detector.

11. The fuel cell according to claim 7, wherein the hydrogen generator comprises:
a fuel tank storing the aqueous solution of chemical hydride;
the reactor connected to the fuel tank to receive the aqueous solution of chemical hydride and supplying the generated hydrogen to the electricity generator; and
the catalyst packed in the reactor.

12. The fuel cell according to claim 11, wherein the temperature controller comprises:
a cooling system operating to cool the reactor according to the temperature sensed by the temperature sensor.

13. The fuel cell according to claim 12, wherein the cooling system includes one of an air-cooling system, a water-cooling system and a combination of them.

14. The fuel cell according to claim 11, further comprising a valve to control the amount of the aqueous solution of chemical hydride discharged from the fuel tank into the reactor, and the valve is controlled by the controller based on the signal transferred from the detector.

15. The fuel cell according to claim 8, wherein the electricity generator includes an anode, a cathode and a polymer electrolyte membrane interposed between the anode and the cathode.

16. The fuel cell according to claim 7, wherein the hydrogen generator further comprises:
a transferring device capable of transferring the catalyst into the aqueous solution of chemical hydride and transferring the catalyst out of the aqueous solution of chemical hydride, the transferring device controlled by the controller based on the signal transferred from the detector; and
the temperature controller comprises a cooling system operating to cool the aqueous solution of chemical hydride, the cooling system controlled by the controller according to the temperature sensed by the temperature sensor.

17. The fuel cell according to claim 16, wherein the controller controls the cooling system to cool the aqueous solution of chemical hydride when the temperature detected by the temperature sensor is above the predetermined temperature, and the controller stops the cooling system when the temperature detected by the temperature sensor is not above the predetermined temperature.

18. The fuel cell according to claim 7, wherein the hydrogen generator further comprises:
a fuel tank storing the aqueous solution of chemical hydride, the reactor connected to the fuel tank to receive the aqueous solution of chemical hydride, the catalyst packed in the reactor and supplying the generated hydrogen to the electricity generator, and a valve to control the amount of the aqueous solution of chemical hydride discharged from the fuel tank into the reactor, the valve controlled by the controller based on the signal transferred from the detector; and
the temperature controller comprises a cooling system operating to cool the reactor according to the temperature sensed by the temperature sensor, and the cooling system includes one of an air-cooling system, a water-cooling system and a combination of them.

19. The fuel cell according to claim 18, wherein the controller controls the cooling system to cool the reactor when the temperature detected by the temperature sensor is above the predetermined temperature, and the controller stops the cooling system when the temperature detected by the temperature sensor is not above the predetermined temperature.

20. The fuel cell according to claim 8, wherein the electricity generator includes an anode, a cathode and a polymer electrolyte membrane interposed between the anode and the cathode.

21. A method of regulating an amount of a chemical reaction in a hydrogen generator comprising:
measuring a temperature of the hydrogen generator;
communicating a signal of the measured temperature to a control circuit;
determining whether the temperature is at a predetermined temperature range; and
decreasing an amount of the chemical reaction between a catalyst and an aqueous solution of chemical hydride when the temperature of the hydrogen generator is higher than the predetermined temperature range.

22. The method of claim 21, wherein a transferring device is used to transfer the catalyst away from the aqueous solution of-chemical hydride when the temperature of the hydrogen generator is higher than the predetermined temperature range.

23. The method of claim 21, wherein a temperature sensor is used to monitor the temperature of the aqueous solution of chemical hydride in the hydrogen generator.
